(19) United States
(12) Patent Application Publication
(10) Pub. No.: US 2012/0118422 A1
(43) Pub. Date: May 17, 2012

(54) Shield for Diverting Air Flow

(76) Inventor: Raymond J. Rotell, Sharpsville, PA (US)

(21) Appl. No.: 13/292,963

(22) Filed: Nov. 9, 2011

Related U.S. Application Data
(60) Provisional application No. 61/412,683, filed on Nov. 11, 2010.

(51) Int. Cl. F16L 55/00

(52) U.S. Cl. 138/103

(57) ABSTRACT

A movable shield for directing air flow to or from a heating and air conditioning unit is described. The shield defines a duct for directing air flow. The duct can be positioned vertically so that airflow occurs in a preferred direction. The shield has a panel and a plurality of connectors for movably securing the shield to a vertical surface. Moving the shield can overcome the natural convective tendencies of treated air. Heated air can be directed downward, and cooled air can be directed upward. This can improve energy efficiency.

The present invention claims priority to and incorporates by reference U.S. provisional application No. 61/412,683.

### FIELD OF THE INVENTION

The invention relates to an article for diverting air flow from a heating and air conditioning unit so as to improve efficiency.

### BACKGROUND OF THE INVENTION

Central heating and air conditioning systems treat air and then convey the treated air through ducts to ventilators from which the air is diffused into rooms. Treatment can include either heating or cooling the air so that the treated air can be regulated to provide air at a desired temperature and comfort for human occupants.

Treated air is generally introduced into a room under the influence of a blower system. The blower system is often located in a central location of the system. Once introduced into the room, the treated air rapidly loses momentum generated by the blower system. Movement of the treated air through the room is typically left to convective currents. Cool air tends to fall once in the room while hot air tends to rise.

The architectural design of rooms can place ventilators at floors, baseboards, ceilings, or along walls. Therefore, ventilators near or at the floor tend to be efficient for heating, but less efficient for cooling. Conversely, ventilators at or near the ceiling tend to be efficient for cooling but less efficient for heating. The cost of providing two types of ventilators, one for hot treated air and one for cool treated air, can be prohibitive. As a result, compromise can place ventilators at or near the vertical center of a room.

Thermostat placement can also create problems. Contractors often place a controlling thermostat near a ventilator. The thermostat heats and cools faster than the room. This causes excessive cycling of the heating and air conditioning system and fails to provide comfortable air temperatures for the occupant.

### SUMMARY OF THE INVENTION

The invention includes a movable shield for directing air flow to or from a heating and air conditioning unit. The shield defines a duct for directing air flow. The duct can be positioned vertically so that airflow occurs in a preferred direction. For example, heated air from a ventilator can be directed downward along a floor so that convective currents favor distribution of the heated air throughout the room. Alternatively, cooled air can be directed upward.

The shield includes a panel comprising a plurality of connectors for movably securing the shield to a vertical surface. Connectors include fasteners that permit moving the shield in a vertical direction.

In embodiments, the shield includes a panel and a plurality of magnetic connectors. The connectors can be placed so that when secured to a vertical metal surface the shield and the vertical surface define a duct. The vertical surface can be, for example, a wall or heating and air conditioning unit. The shield can comprise a flexible panel.

In alternative embodiments, the shield includes at least one brace that fixes the shield in a configuration. Braces can include chains, strings, cables, filaments, and combinations thereof.

In one embodiment, the shield comprises a flexible sheet, a plurality of magnetic connectors, and bracing. The bracing bends the flexible sheet into a shape that permits the magnetic connectors to secure to a vertical metal surface, thereby defining a duct for directing air flow. The flexible sheet can comprise a metal sheet or polymeric material, such as vinyl or polyolefin.

### BRIEF DESCRIPTION OF THE DRAWINGS

FIG. 1 shows a front view of an embodiment of the invention.

FIG. 2 shows a rear view of the embodiment of FIG. 1.

FIG. 3 shows a side view of the embodiment of FIG. 1.

FIG. 4 shows a rear view of the embodiment of FIG. 1 before the bracing is connected.

FIG. 5 shows a rear view of the embodiment of FIG. 1 with the bracing connected.

FIG. 6 shows a front view of the embodiment of FIG. 1 attached vertically to a first surface.

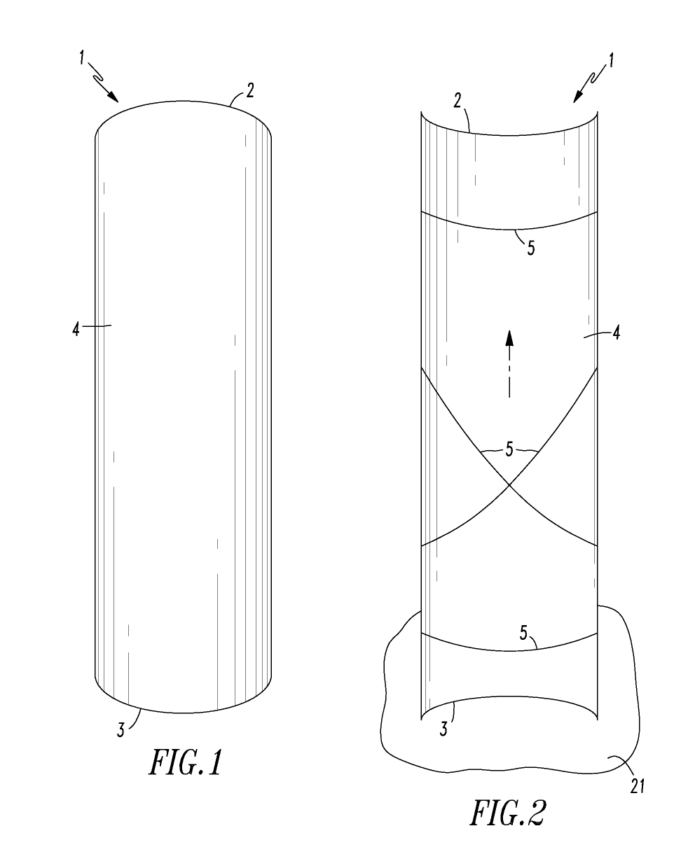

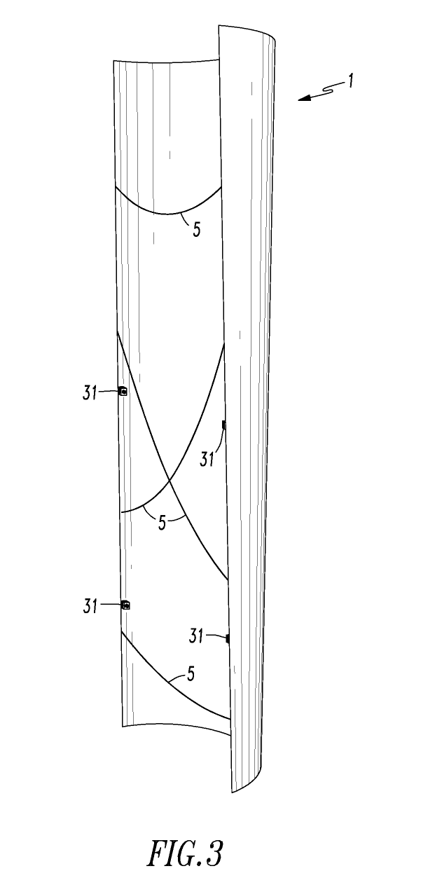

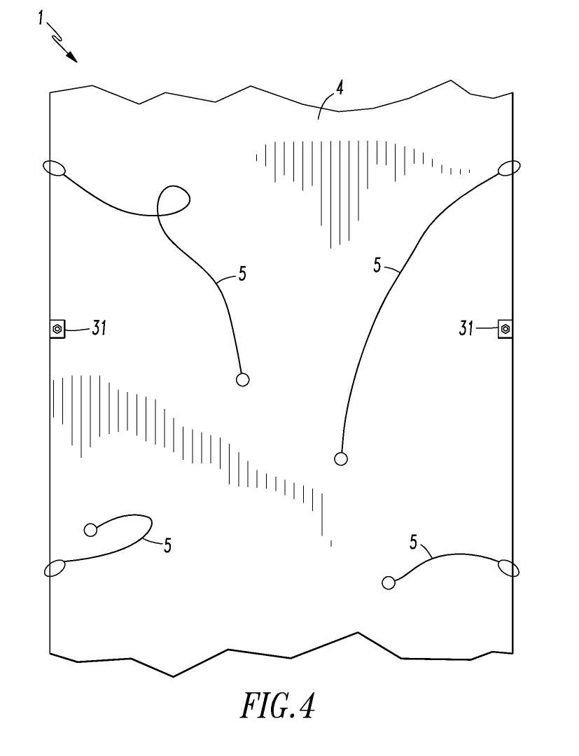

### DETAILED DESCRIPTION OF THE INVENTION

The figures show an embodiment of the invention. A shield 1 for diverting airflow includes a sheet 4 defining a duct having a first open end 2 and a second open end 3. The shield comprises any convenient material including, for example, metal, treated paper or cardboard, and plastic sheet. In embodiments, the shield comprises a flexible plastic sheet, such as vinyl sheet.

As shown in FIG. 2, the sheet 4 can be formed into a U-shaped configuration using at least one brace 5. The U-shape can be movably secured to a first surface thereby defining a duct for the flow of air. Braces 5 can include any item capable of tensioning the sheet 4, including chains, strings, cables, filaments, and combinations thereof. Braces 5 can be secured to complimentary locations on either side of the sheet 4 or can be crisscrossed for lateral stability. FIG. 2 shows the second open end 3 of the shield 1 closed by a second surface, namely the floor 21. In such a configuration, the shield 1 would direct airflow upward. Alternatively, the second open end can be closed by a ceiling to divert the airflow downward. The second open end can even be closed by placement near a wall.

The shield 1 comprises connectors 31. The connectors 31 secure the shield 1 to a surface and permit movement of the shield 1 along the surface. Connectors can include any fasteners that permit moving the shield in a vertical direction including, for example, magnets, Velcro, and tracks. In embodiments, the connectors 31 can include magnets that secure the shield 1 to a metallic surface, such as might be found on a heating and air conditioning unit.

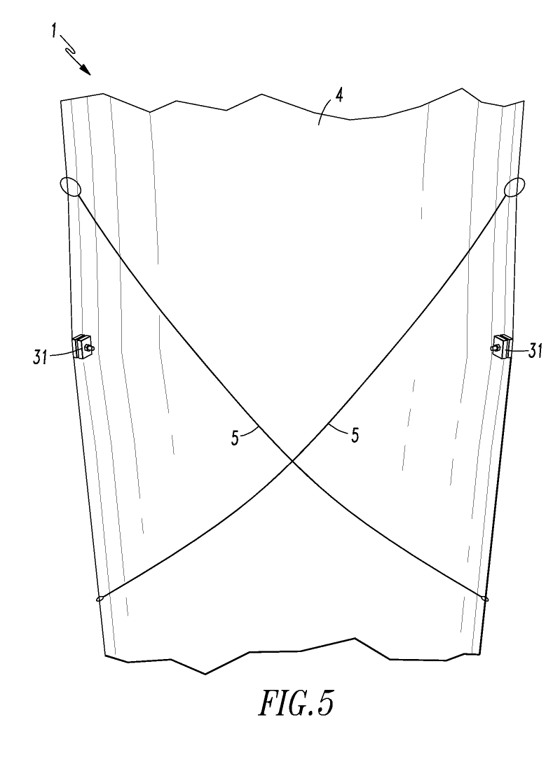

FIG. 4 shows a shield 1 comprising a flexible sheet 4 having a plurality of braces 5 and connectors 4. Attaching the braces 5 to complimentary locations on the sheet 4 bends the sheet 4 into a usable configuration. The configuration will define a duct when secured to a surface with the connectors 31. As can be seen in FIG. 5, the sheet 4 bends as a result of the braces 5 and orients the connectors 31 so that they can secure the shield 1 to a surface. Advantageously, a flexible sheet is more easily stored than a permanently deformed sheet.

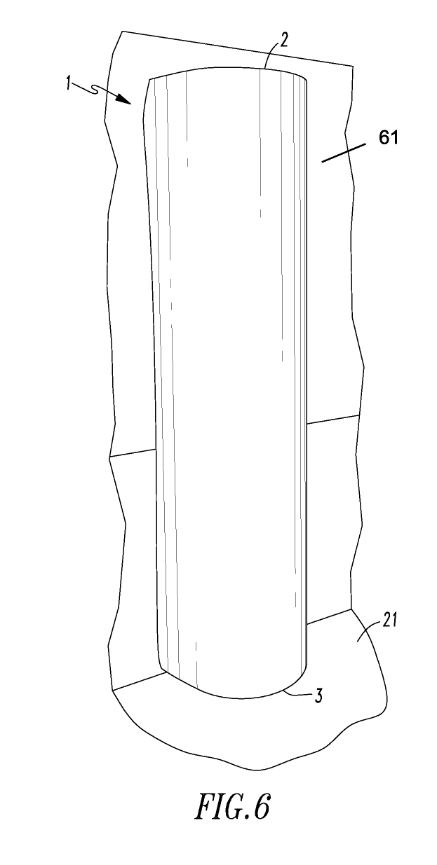

As shown in FIG. 6, the shield 1 can be secured to a first surface 61 using the connectors. The shield can be moved against a second surface 21 adjacent to the vertical surface 61 whereby one open end can be closed by its proximity to the adjacent second surface 21. The second surface can include, for example, a ceiling, a wall or a floor. In a first position, as shown in FIG. 6, the shield 1 extends to the floor 21 thereby closing the second open end 3. The first open end 2 remains open so that airflow can occur only through this end. Alternatively, the shield can be secured to a vertical surface so that the first open end extends to the ceiling, and air flow can occur only through the second open end. In other embodiments, the shield can define a duct having one open end and one closed end. The open end is positioned in the direction of the intended airflow. The same shield can be rotated if airflow in the opposite direction is desired.

In practice, the shield can be secured to a heat and air conditioning outlet. In heating mode, the shield can be raised from the surface so that heated air outflow occurs preferentially out the second open end along the floor. In cooling mode, the shield can be lowered so that cool air outflow occurs preferentially out the first open end along a ceiling. Of course, the positioning can be reversed for an air intake.

### EXAMPLE

Two identical, one-story condominium units were used to test the efficiency of the air diverting shield of the present invention. The units were new construction less than six months old, and were extremely well insulated including the walls, ceiling, windows and doors. The units had identical heating and cooling systems. Only the second unit included the device of the present invention.

Digital thermostats in the two units were set to cool to identical temperatures. An air diverting shield was placed over each unit's air discharge vent and positioned so that the discharged air, that is, cool air, was directed to the ceiling. Both units were vacated and locked at the same time. The cooling systems were allowed to operate without interruption for four days. Energy consumption was measured using the supplying electric company's digital kilowatt-hour meters. Independent monitoring equipment corroborated thermostat readings.

The second unit with the air diverting shield showed energy savings of 3.5% when compared to the first unit without the shield. Energy savings in “real-world” conditions is expected to be higher because the amount of cooling required to maintain temperature in a sealed environment is much less than in an open environment where doors and windows open and heat is produced by appliances and lighting.

What is believed to be the best mode of the invention has been described above. However, it will be apparent to those skilled in the art that numerous variations of the type described could be made to the present invention without departing from the spirit of the invention. The scope of the present invention is defined by the broad general meaning of the terms in which the claims are expressed.

1. A shield for diverting air flow from a heating and cooling outlet comprising (a) a sheet defining a duct with at least one open end when secured to a first surface, and (b) at least one connector for securing the shield to the first surface.

2. The shield of claim 1, wherein the sheet defines a duct with two open ends, whereby one end can be closed by placing the shield against a second surface adjacent to the first surface.

3. The shield of claim 1, wherein the second surface is selected from a group consisting of a ceiling, a floor or a wall.

4. The shield of claim 1, wherein the sheet comprises a flexible material and is bent to define the duct.

5. The shield of claim 1, wherein the sheet comprises a material selected from a group consisting of metal, paper, cardboard, and plastic sheet.

6. The shield of claim 1, wherein the sheet comprises a flexible plastic sheet.

7. The shield of claim 1, wherein the connector permits movement of the shield along the first surface.

8. The shield of claim 1, wherein the connector is selected from a group consisting of a magnet, Velcro, a track, and combinations thereof.

9. A shield for diverting air flow from a heating and cooling device comprising (a) a flexible sheet bent into a U-shaped configuration using at least one brace thereby defining a duct with at least one open end when secured to a first surface, and (b) at least one connector for securing the shield to the surface.

10. The shield of claim 9, wherein the brace includes a group consisting of chains, strings, cables, filaments, and combinations thereof.

11. The shield of claim 9, wherein the brace is secured to complimentary locations on at least two sides of the sheet.

12. The shield of claim 9, wherein at least two braces are secured in complimentary locations on at least two sides of the sheet in a crisscrossed pattern.

13. A process for using a shield for diverting air flow from a heating and cooling outlet, the sheet comprising (a) a sheet defining a duct with at least one open end when secured to a first surface, and (b) at least one connector for securing the shield to the first surface.

14. The process of claim 13, wherein the sheet is a flexible sheet bent into a U-shaped configuration using at least one brace.

15. The process of claim 13, wherein the open end directs heated air to a floor.

16. The process of claim 13, wherein the open end directs cooled air to a ceiling.

17. The process of claim 13, wherein the sheet defines a duct with two open ends, and one open end is closed by placing the shield against a second surface adjacent to the first surface.

18. The process of claim 17, wherein the second surface is selected from a group consisting of a ceiling, a floor or a wall.
